(19) United States
(12) Patent Application Publication
(10) Pub. No.: US 2018/0321164 A1
(43) Pub. Date: Nov. 8, 2018

(54) METHOD OF ANALYZING MOLECULAR PROPERTIES AND SPECTROMETER FOR THE SAME

(71) Applicants: THE UNIVERSITY COURT OF THE UNIVERSITY OF GLASGOW, Glasgow Strathclyde (GB); MAX-PLANCK-GESELLSCHAFT ZUR FÖRDERUNG DER WISSENSCHAFTEN E.V., München (DE)

(72) Inventors: Robert P. CAMERON, Glasgow Strathclyde (GB); Jörg B. GÖTTE, Glasgow Strathclyde (GB); Stephen M. BARNETT, Glasgow Strathclyde (GB)

(73) Assignees: THE UNIVERSITY COURT OF THE UNIVERSITY OF GLASGOW, Glasgow Strathclyde (GB); MAX-PLANCK-GESELLSCHAFT ZUR FÖRDERUNG DER WISSENSC HAFTEN E.V., München (GB)

(21) Appl. No.: 15/773,961

(22) PCT Filed: Nov. 4, 2016
(86) PCT No.: PCT/EP2016/076742

§ 371 Date: May 4, 2018

(30) Foreign Application Priority Data
Nov. 6, 2015 (GB) 1519681.9

(51) Int. Cl. G01N 22/00

(52) U.S. Cl. CPC G01N 22/00

(57) ABSTRACT

A new spectroscopic technique and corresponding spectrometer for molecules in which optical radiation is used to shift the rotational/nuclear-spin energy levels of freely rotatable sample molecules, and in which these shifts are detected using probing radiation. This technique enables the determination of individual polarizability components and/or combinations of these and/or information about the constitution of a sample that follows from these. In particular, it can reveal the enantiomeric constitution of a chiral sample whilst yielding a non-vanishing signal even for a racemate. The technique may find particular use in the analysis of molecules that are chiral by virtue of their isotopic constitution and molecules with multiple chiral centres.

### CROSS-REFERENCE TO RELATED APPLICATIONS

This is a U.S. national phase application under 35 U.S.C. § 371 of International Patent Application No. PCT/EP2016/076742, filed Nov. 4, 2016, and claims benefit of priority to Great Britain Patent Application No. 1519681.9, filed Nov. 6, 2015. The entire contents of these applications are hereby incorporated by reference.

### FIELD OF THE TECHNOLOGY

The invention relates to a method for analyzing sample molecules and a spectrometer for the same. In particular, the invention presents a spectroscopic technique for probing rotational transitions of molecules that is capable of yielding information about their chirality.

### BACKGROUND

Chirality pervades the natural world, and is of particular importance to life, as the molecules that make up living things are invariably chiral, and their chirality is crucial to their biological function.

A molecule possesses electronic, vibrational and rotational degrees of freedom which can be considered separately, to a zeroth degree approximation. Manifestations of chirality in the electronic and vibrational degrees of freedom can be probed using optical rotation (resulting from different phase velocities for left circularly polarized (LCP) and right circularly polarized (RCP) light) and circular dichroism (the differential absorption of LCP and RCP light by a sample). Vibrational degrees of freedom can also be probed using Raman optical activity (the differential scattering of LCP and RCP light).

However, manifestations of chirality residing purely in the rotational degrees of freedom of chiral molecules remain largely unexplored. This is despite the fact that rotational spectroscopy has been employed to probe other, non-chirally specific geometrical properties of molecules such as bond lengths and bond angles.

Microwave optical rotation and circular dichroism have been suggested as methods for probing manifestations of chirality residing purely in the rotation degrees of freedom of chiral molecules. However, these effects are expected to be weak owing to the small size of the molecules relative to the inherent twist of circularly polarized microwaves.

The concept of rotational Raman optical activity arises from an expected difference in the pure rotational Raman scattering of RCP and LCP light. Rotational Raman optical activity has not yet been observed in an experiment owing primarily to the anticipated proximity of the relevant Stokes and anti-Stokes lines to the Rayleigh line.

### SUMMARY

At its most general, the invention proposes a new spectroscopic technique for molecules that enables the determination of individual polarizability components including α_{XX}, α_{YY}, α_{ZZ}, α′_{YZ,X}, α′_{ZX,Y}, α′_{XY,Z}, G′_{XX}, G′_{YY}, G′_{ZZ}, A_{X,YZ}, A_{Y,ZX} and A_{Z,XY} (in the notation used by L. Barron in ‘Molecular Light Scattering and Optical Activity’, 2nd edition (Cambridge University Press, Cambridge, 2004), as defined explicitly below) and/or combinations of these and/or information about the constitution of a sample that follows from these. In particular, it reveals the enantiomeric constitution of a chiral sample whilst yielding a non-vanishing signal even for a racemate. The technique may find particular use in the analysis of molecules that are chiral by virtue of their isotopic constitution and molecules with multiple chiral centres.

The technique of the invention is the use of optical radiation to shift the rotational/nuclear-spin (referred to simply as “rotational” from here onwards) energy levels of freely rotatable sample molecules together with the detection of these shifts using probing radiation.

Herein, the term “freely rotatable sample molecules” may mean molecules that enjoy substantially unimpeded rotational dynamics. For example, the sample may be a molecular beam or in the gas phase.

Accordingly, the present invention provides a method of rotational spectroscopy, the method comprising: introducing a sample into a sample chamber, wherein the sample comprises freely rotatable molecules; illuminating the sample with optical radiation having a polarization selected to introduce a shift in rotational energy levels of the sample molecules; and irradiating the sample with probing radiation to obtain rotational spectral data from which the shift in rotational energy levels of the sample molecules can be derived.

The optical radiation may comprise or consist of one or more components that are linearly, circularly or elliptically polarized. In particular, the use of circularly or elliptically polarized light (or a chiral superposition of such light) can be used to induce shifts in the rotational energy levels which are different for opposite molecular enantiomers, the difference depending on optical activity polarizability components. This makes it possible to determine the enantiomeric constitution of a sample from the rotational spectral data.

The frequency and intensity of the optical radiation should be such that shifts are large enough to be resolved by the probing radiation whilst also ensuring that absorption of the optical radiation by the molecules is small. The optical radiation is preferably in the visible or infrared parts of the spectrum. For example, the optical radiation may have a wavelength in the range 4×10⁻⁷ m to 1.5×10⁻⁶ m. For wavelengths lower than 4×10⁻⁷ m (entering into the ultraviolet), electronic absorption becomes increasingly likely for many species. For wavelengths above 1.5×10⁻⁶ m (extending beyond the near-infrared), vibrational overtone absorption becomes increasingly likely for many species.

The probing radiation acts to induce transitions between the rotational energy levels of the molecules. This allows the shifts to be observed. For example, the shifts can be compared with an unshifted rotational spectrum (i.e. a rotational spectrum obtained in the absence of the optical radiation), e.g. to yield values for individual polarizability components. Alternatively or additionally, the shifted rotational spectral data can be used in isolation in order to determine the relative proportion of different enantiomers in a given sample of chiral molecules.

By extracting data about the shifts between one or a plurality of rotational energy levels, perhaps under a plurality of different experimental conditions, it becomes possible to extract individual polarizability components for the molecule, e.g. including any of α_{XX}, α_{YY}, α_{ZZ}, α′_{YZ,X}, α′_{ZX,Y}, α′_{XY,Z}, G′_{XX}, G′_{YY}, G′_{ZZ}, A_{X,YZ}, A_{Y,ZX} and A_{Z,XY} and/or combinations of these.

Alternatively or additionally, the rotational spectral data may itself be indicative of a given molecule (or of the chirality of a given molecule), i.e. it may represent a “fingerprint” of that molecule. The method may include comparing the rotational spectral data with reference data to determine information about the sample. For example, this technique may be used in sample purity testing, or to immediately determine the constitution of any given sample, in an isomerically and/or enantiomerically sensitive manner, without requiring further tests.

The irradiating step for obtaining the rotational spectral data may use known rotational spectroscopic techniques. For example, the probing radiation may be microwave or radiofrequency energy. Microwave energy may be preferred because transitions between rotational energy levels usually have frequencies between 10⁹ s⁻¹ and 10¹¹ s⁻¹.

The rotational spectral data may have any form that is indicative of the shift in rotational energy levels. For example, the rotational spectral data may comprise rotational absorption spectral data, transmission data or free-induction decay data.

The method may include applying a static magnetic field across the chamber. The static magnetic field may define, in conjunction with the optical radiation, a quantization axis for the rotational and nuclear spin degrees of freedom of molecules. In some embodiments, the static magnetic field may act to separate the rotational and nuclear spin degrees of freedom of molecules to a good approximation. Alternatively or additionally, the magnetic field may be utilised to enable the determination of magnetically sensitive polarizability components including any of α′_{YZ,X}, α′_{ZX,Y} and α′_{XY,Z} or any combination of these and/or to gain information about the constitution of a sample that follows from these.

We will now illustrate the nature of the shifts for a particular molecular model and under a particular set of circumstances. Note, however, that the existence of these shifts and, moreover, the functionality of particular embodiments of spectrometers (discussed below) do not depend upon any particular method of calculation or approximation.

Consider then a molecule that is at rest or moving slowly relative to laboratory-fixed axes x,y,z whilst occupying its vibronic ground state, in which it is small, polar and non-paramagnetic. We describe the rotation of the molecule as that of an asymmetric rigid rotor, with equilibrium rotational constants A>B>C associated with rotations about the molecule's principal axes of inertia X, Y and Z. Suppose that the molecule is illuminated by optical radiation in the form of an off-resonance circularly polarised beam of visible or near-infrared light of moderate intensity I and wavevector k pointing in the z direction, with σ=±1 for LCP or RCP. We restrict our attention to a short time interval following a short illumination time, such that the probability of absorption and other dissipative processes can be neglected. The optical radiation can be said then to simply drive oscillations in the charge and current distributions of the molecule, which shifts the rotational energy levels of the molecule by

$$Δ {W}_{light} = I [ A {α}_{XX} + B {α}_{YY} + C {α}_{ZZ} + σ ( {A}^{′} {G}_{XX}^{′} + {B}^{′} {G}_{YY}^{′} + {C}^{′} {G}_{ZZ}^{′} ) + σ \vert k \vert ( {DA}_{X , YZ} + {EA}_{Y , ZX} + {FA}_{Z , XY} ) ] + ⋯$$

where A, B, C, D, E and F are constants that differ for the different rotational states of the molecule, with A′=−2A/c, B′=−2B/c and C′=−2C/c where c is the speed of light. α_{XX}, α_{YY} and α_{ZZ} are components of the electric-dipole/electric-dipole polarizability, which do not distinguish between opposite enantiomers. G′_{XX}, G′_{YY}, and G′_{ZZ} are components of the electric-dipole/magnetic-dipole polarizability taken about the molecule's centre of mass, which each have equal magnitudes but opposite signs for opposite enantiomers if the molecule is chiral and vanish otherwise. A_{X,YZ}, A_{Y,ZX}, and A_{Z,XY} are components of the electric-dipole/electric-quadrupole polarizability taken about the molecule's centre of mass, which each have equal magnitudes but opposite signs for opposite enantiomers if the molecule is chiral and vanish otherwise. This, ΔW_{light}, is the a.c. Stark shift, but calculated here to higher order than is usually done. If a static magnetic field B of moderate intensity pointing in the z direction is applied, then the above becomes

$$Δ {W}_{light} = I [ A {α}_{XX} + B {α}_{YY} + C {α}_{ZZ} + σ ( {A}^{′} {G}_{XX}^{′} + {B}^{′} {G}_{YY}^{′} + {C}^{′} {G}_{ZZ}^{′} ) + σ \vert k \vert ( {DA}_{X , YZ} + {EA}_{Y , ZX} + {FA}_{Z , XY} ) + σ {B}_{z} {k}_{z} ( G {α}_{YZ , X}^{′} + H {α}_{ZX , Y}^{′} + I {α}_{XY , Z}^{′} ) / \vert k \vert ] + ⋯$$

where G, H and I are additional constants that differ for the different rotational states of the molecule. α′_{YZ,X,}, α′_{ZX,Y,} and α′_{XY,Z}are components of the “Faraday-B” polarizability, which do not distinguish between opposite enantiomers.

It is shifts such as these that are to be detected by probing radiation to determine individual polarizability components including α_{XX}, α_{YY}, α_{ZZ}, α′_{YZ,X}, α′_{ZX,Y}, α′_{XY,Z}, G′_{XX}, G′_{YY}, G′_{ZZ}, A_{X,YZ}, A_{Y,ZX} and A_{Z,XY} and/or combinations of these, as well as information about the constitution of a sample that follows from these. For example, the energy required to induce a molecular transition in the scenario described above has a contribution of the form

$$I [ Δ A {α}_{XX} + Δ B {α}_{YY} + Δ C {α}_{ZZ} + σ ( Δ {A}^{′} {G}_{XX}^{′} + Δ {B}^{′} {G}_{YY}^{′} + Δ {C}^{′} {G}_{ZZ}^{′} ) + σ \vert k \vert ( Δ {DA}_{X , YZ} ) + Δ {EA}_{Y , ZX} + {FA}_{Z , XY} ) + σ {B}_{z} {k}_{z} ( Δ G {α}_{YZ , X}^{′} + Δ H {α}_{ZX , Y}^{′} + Δ I {α}_{XY , Z}^{′} ) / \vert k \vert ] + ⋯$$

where ΔA is the difference between the particular values of A in the two rotational states involved in the transition and similarly for ΔB, ΔC, ΔA′, ΔB′, ΔC′, ΔD, ΔE, ΔF, ΔG, ΔH and ΔI.

The concept above can be contrasted with conventional optical rotation experiments. The basic property of a chiral molecule that is probed in a typical optical rotation experiment using a fluid sample is the isotropic sum

⅓(G′_{XX}+G′_{YY}+G′_{ZZ}).

The experiment does not give these components individually. Moreover, it yields no information about the polarizability components A_{X,YZ}, A_{Y,ZX}, and A_{Z,XY}, which also make contributions to optical rotation that are individually comparable to those from G′_{XX}, G′_{YY}, and G′_{ZZ} but which vanish on isotropic averaging.

Whilst the techniques of circular dichroism and Raman optical activity yield other chirally sensitive molecular properties, the fact remains that it is the isotropically-averaged molecular properties that are usually probed in such experiments.

The technique of the invention may be relevant for all types of molecules (i.e. chiral and achiral). However, it provides particular advantages in the analysis of chiral molecules, because it enables individual components of molecular optical activity polarizabilities to be extracted. For example, the method may include analyzing the rotational spectral data to extract any one or more of α_{XX}, α_{YY}, and α_{ZZ} (individual components of the electric-dipole/electric-dipole polarizability); G′_{XX}, G′_{YY}, and G′_{ZZ} (individual components of the electric-dipole/magnetic-dipole polarizability); A_{X,YZ}, A_{Y,ZX}, and A_{Z,XY} (individual components of the electric-dipole/electric-quadrupole polarizability); and α′_{YZ,X}, α′^{ZX,Y}, and α′_{XY,Z} (components of the molecule's “Faraday-B” polarizability).

The technique discussed above can be performed using a spectrometer that is another aspect of the invention.—According to this aspect there is provided a spectrometer for performing molecular rotational spectroscopy, the spectrometer comprising: a sample chamber for receiving and retaining a sample comprising freely rotatable molecules; an optical source configured to illuminate the sample chamber with optical radiation having a polarization selected to introduce a shift in the rotational energy levels of the sample molecules; a probing radiation generator configured to irradiate the sample with probing radiation; a detector configured to detect rotational spectral data from which the shift in the rotational energy levels of the sample molecules can be derived.

The spectrometer may include a field generator for applying a static magnetic field across the sample chamber. The static magnetic field may define, in conjunction with the optical radiation, a quantization axis for the rotational and nuclear spin degrees of freedom of molecules. In some embodiments, the static magnetic field may act to separate the rotational and nuclear spin degrees of freedom of molecules to a good approximation. Alternatively or additionally, the magnetic field may be utilised to enable the determination of magnetically sensitive polarizability components including any of α′_{YZ,X}, α′_{ZX,Y} and α′_{XY,Z} or any combination of these and/or to gain information about the constitution of a sample that follows from these.

### Sampling

The sample may be introduced to the sample chamber using any conventional technique. For example, the sample molecules may be introduced to the sample chamber via a nozzle in the form of a pulsed molecular beam. A skimmer may be employed to collimate the molecular beam to maximise the number of molecules illuminated by the light. The skimmer may be shielded from the optical radiation.

As another example, the sample chamber may include an injection inlet that acts as a continuous or quasi-continuous source for sample molecules. As the molecules emerge from the inlet they may diffuse through a cold buffer gas to cool them (see below). This configuration may allow measurements to be taken at a higher rate than the pulsed nozzle configuration. In particular, measurements can be taken once per free-induction decay, if rotational data is obtained using a pulsed probing radiation technique, because the inlet provides a continuous stream of molecules. In contrast, in the pulsed nozzle case, the sample chamber may need to be evacuated between every pulse, meaning that measurements can only be taken once per vacuum pumping cycle. By taking measurements more frequently, as in the continuous-source inlet case, a higher signal-to-noise ratio can be achieved.

It is desirable for the molecules in the sample chamber to be cold, i.e. translating slowly whilst occupying a small collection of rotational and nuclear spin states in the vibronic ground state only. Accordingly, the sample chamber may include a cooling device arranged to maintain the temperature of the sample at a low level, e.g. less than 50 K, preferably less than 20 K. In an embodiment like the second one described above, the sample chamber may include an inlet for introducing cold gas, preferably helium, into the sample chamber. The gas may have a temperature of no more than 10 K. The inlet for introducing cold gas may be the same inlet as the inlet for introducing sample molecules into the sample chamber. When the spectrometer is in use, a stream of the sample molecules may be funnelled into the sample chamber to make contact with the cold gas. As the sample molecules diffuse through the cold gas, collisions between the sample molecules and the molecules/atoms of the cold gas cause the sample molecules to be internally cooled until they reach a wall of the sample chamber and likely condense. The presence of a cold gas may have the additional advantage of cooling the other components of the spectrometer, which may be heated by the optical radiation. In particular, the cold gas may cool the optical resonator and/or microwave cavity. To compensate for the heating of the cold gas by the optical radiation and the contact with the sample molecules, the sample chamber may also include a cold gas outlet, so that a small quantity of (heated) gas can be leaked out of the sample chamber and replaced at an equal rate to maintain a constant temperature. The cold gas may also be used to cool the microwave detector(s), thus decreasing thermal noise.

Some or all of the components of the spectrometer may reside in a vacuum chamber. A pressure of ≤0.1 Pa may be maintained in the vacuum chamber using a vacuum pump, which may be a diffusion pump. A low pressure environment inside the spectrometer reduces atmospheric contributions to the spectra generated by the spectrometer. The diffusion pump may be inactive during periods when measurements are being taken. If the diffusion pump is active during periods when measurements are being taken, the diffusion pump may be vibrationally shielded from the vacuum chamber, in order to reduce its impact on other sensitive components.

### Optical Radiation and Associated Shifts

It is important that the optical radiation for illuminating the sample is capable of inducing observable shifts. The optical source may comprise an optical resonator. The optical resonator may have a cavity which is contained within or part of the sample chamber. The optical radiation may be confined within an optical resonator. The cavity may be arranged to support a particular polarization of light. For example, a Fabry-Pérot cavity can be used to contain a linearly polarized standing wave. Alternatively, a ring cavity may be used to support a circularly polarized travelling wave. It is desirable to control the spatial extent of the optical radiation to ensure that as large a fraction as possible of the sample molecules experience light-induced shifts thus enhancing the signal to noise ratio and/or to ensure that transit-time broadening is not so large that it renders the shifts unobservable.

The details of the optical resonator and the characteristics of the light illuminating the sample molecules may vary depending on the properties that the spectrometer is being used to measure. For example, if α_{XX}, α_{YY} and α_{ZZ} are to be measured, then the light preferably has an intensity of no less than 10⁴ W·cm⁻² (assuming a resolution of 10⁴ Hz). In this case, linearly polarized light may be used, in the Fabry-Pérot cavity discussed above. On the other hand, if measurements of α′_{YZ,X}, α′_{ZX,Y}, α′_{XY,Z}, G′_{XX}, G′_{YY}, G′_{ZZ}, A_{X,YZ}, A_{Y,XZ} and A_{Z,XY} are to be obtained, then the light may be circularly- or elliptically-polarized and preferably has an intensity of no less than 10⁷ W·cm⁻² (assuming a resolution of 10⁴ Hz). In the latter case, the bow tie-shaped ring cavity may be used as an optical resonator, accommodating a travelling wave. The optical source may include a polarizing element arranged to introduce the required polarisation. The polarizing element is preferably located outside the sample chamber.

In general, the shift in a transition frequency due to the optical radiation will have contributions that are both chirally insensitive and chirally sensitive. For most transitions available to a given molecule, the chirally insensitive contribution is considerably larger in magnitude than the chirally sensitive contribution, which itself should be larger than the linewidths involved if the chirally sensitive information is to be resolved. However, the inventors have ascertained that within the large set of available transitions for any given molecule there is normally a group of transitions for which the chirally insensitive shifts are by accident rather small whilst the chirally sensitive shifts are not. Additionally, it may be noted that the isotropic sum (G′_{XX}+G′_{YY}+G′_{ZZ})/3 can be significantly smaller in magnitude than the individual components G′_{XX}/3, G′_{YY}/3 and G′_{ZZ}/3. Transitions involving rotational states of isotropic character may therefore give rise to particularly large chirally sensitive shifts.

It is advantageous to probe transitions with a smaller chirally insensitive contribution because it enables chiroptical information to be obtained without requiring the intensity of optical radiation to be fixed with unreasonably high precision.

### Probing Radiation and Detection

The probing radiation generated by the probing radiation generator may be microwave radiation (microwaves) and/or radio frequency radiation (RF waves). The probing radiation may be monochromatic or quasi-monochromatic, but embodiments using pulsed and modulated sources are also possible. The probing radiation generator and detector may work on the same principles as known cavity-enhanced pulsed Fourier-transform microwave spectrometers. Thus, the probing radiation generator may comprise a microwave Fabry-Pérot cavity, e.g. defined by a pair of mirrors. The pair of mirrors may be parallel plane mirrors, or alternatively the mirrors may be concave. Preferably the Q-factor of the arrangement of mirrors is at least 1000, in order to favourably increase the signal-to-noise ratio and also to ensure that polarising microwave radiation can enter and leave the cavity on a time scale which is short relative to the time scale over which the molecules exhibit their free induction decay.

The probing radiation generator may be configured to deliver a pulse of probing radiation into the cavity defined by the pair of mirrors, the pulse lasting no more than 10⁻⁵ s. The pulse polarizes the shifted rotational transitions lying within a frequency band of at least 10⁵ s⁻¹, and then subsequently decays from the cavity in a very short time. The sample molecules then exhibit free-induction decay over around 10⁻⁴ s. The free-induction decay signals are detected by the detector to provide the rotational spectral data.

The separation between the mirrors may be adjustable in order to vary the frequencies of probing radiation being studied. In order to achieve this, one of the pair of mirrors may be movable relative to the other. More specifically, the mirrors may be connected to the end plates of the vacuum chamber by rods, at least one of the rods being connected to a rack and pinion and gear reduction mechanism in order to move the mirror to which that rod is connected with greater control.

In order to maximize the signal-to-noise ratio, as large a fraction of the sample molecules as possible should be illuminated by the light. Furthermore, each molecule within the sample chamber should ideally experience the same illuminating light intensity and, in those embodiments that include a static magnetic field, the same static magnetic field strength. This ensures a cleanly defined spectrum. For the illuminating light, this may be achieved by using a top-hat beam profile. Those molecules that are not illuminated do not make any useful contribution to the signal detected by the detector. In addition, the overlap of the molecules with the microwave standing wave field should be as large as possible, since the strength of the free-induction decay signal is essentially proportional to the number of molecules polarized.

### Optional Static Magnetic Field

Possibilities for the magnetic field generator include conventional or superconducting Helmholtz or Maxwell coils or combinations of such coils, solenoids and geometrically tunable permanent magnets.

The magnetic field generator-may be located outside the sample chamber, and preferably also outside the cavity of the probe radiation generator. The magnetic field generator is preferably configured to ensure that the field is substantially uniform within the sample chamber.

The strength of the magnetic field may be adjustable or tunable.

The magnetic field generator may be cooled. For example, conventional Helmholtz coils may be water cooled and superconducting Helmholtz coils may be helium cooled.

Some or all of the components other than the magnetic generator, when employed, may be made of non-magnetic materials in order to avoid undesirable interactions with the magnetic field.

### BRIEF DESCRIPTION OF THE DRAWINGS

Embodiments of the invention will now be described by way of example with reference to the accompanying drawings in which:

FIG. 1 shows a schematic plan view of a spectrometer according to an embodiment of the present invention;

FIG. 2 shows a schematic front view of a spectrometer according to an embodiment of the present invention;

FIG. 3 shows a schematic side view of a spectrometer according to an embodiment of the present invention;

FIG. 4A shows a typical arrangement of a Balle-Campbell-Keenan-Flygare pulsed nozzle Fourier transform microwave spectrometer;

FIG. 4B shows a schematic diagram of an adapted Balle-Campbell-Keenan-Flygare pulsed nozzle Fourier transform microwave, according to another embodiment of the present invention;

FIG. 5 shows a molecule of chiral L-alanine, in the presence of a magnetic field B and circularly-polarized light;

FIG. 6 shows the most probable orientations of the molecule-fixed axes X, Y and Z relative to the laboratory-fixed axes x, y and z for some of the molecule's low lying rotor states;

FIGS. 7(a), 7(b), and 7(c) show schematically a rotational absorption line for different settings of the magnetic field B and the light;

FIG. 8 shows an example of isotopic molecular chirality in singly-deuterated chlorofluoromethane;

FIGS. 9(a), 9(b), and 9(c) show schematically a rotational absorption line for a fixed field B, and fixed light settings, and varying enantiomeric compositions; and

FIGS. 10(a) and 10(b) show a comparison of schematic rotational absorption line obtained for a sample of three different stereoisomers using conventional rotational spectroscopy and the spectroscopic technique of the present invention.

### DETAILED DESCRIPTION

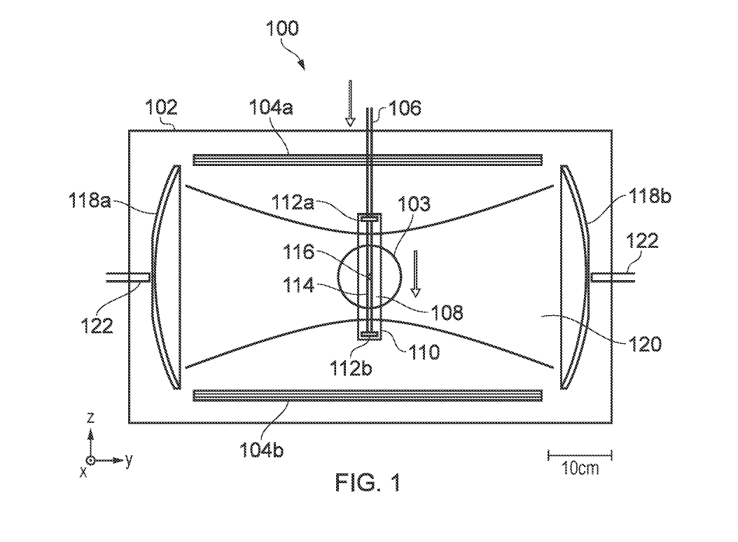

FIGS. 1, 2 and 3 show plan, front and end views of a spectrometer according to an embodiment of the present invention. The majority of the components of the spectrometer 100 shown in FIGS. 1, 2 and 3 reside within vacuum chamber 102. The vacuum chamber is maintained at a low pressure of ≤0.1 Pa by diffusion pump 103.

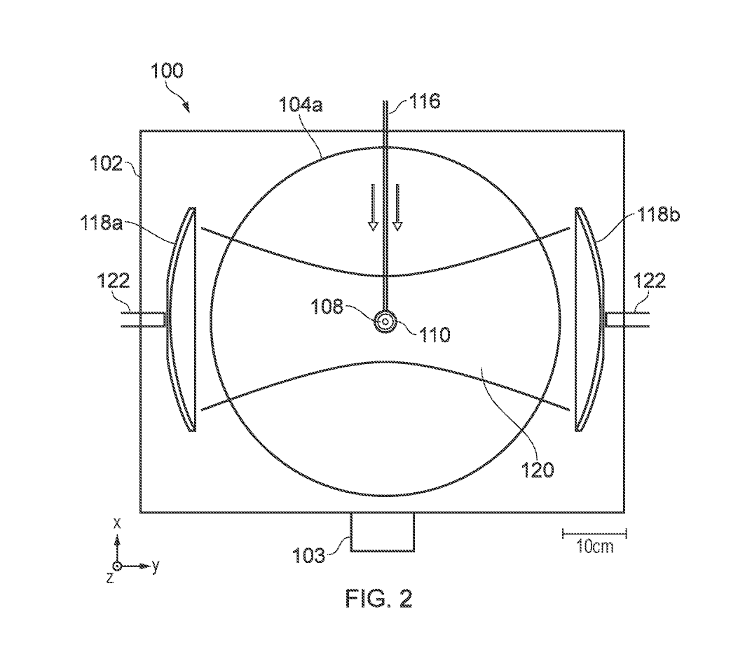

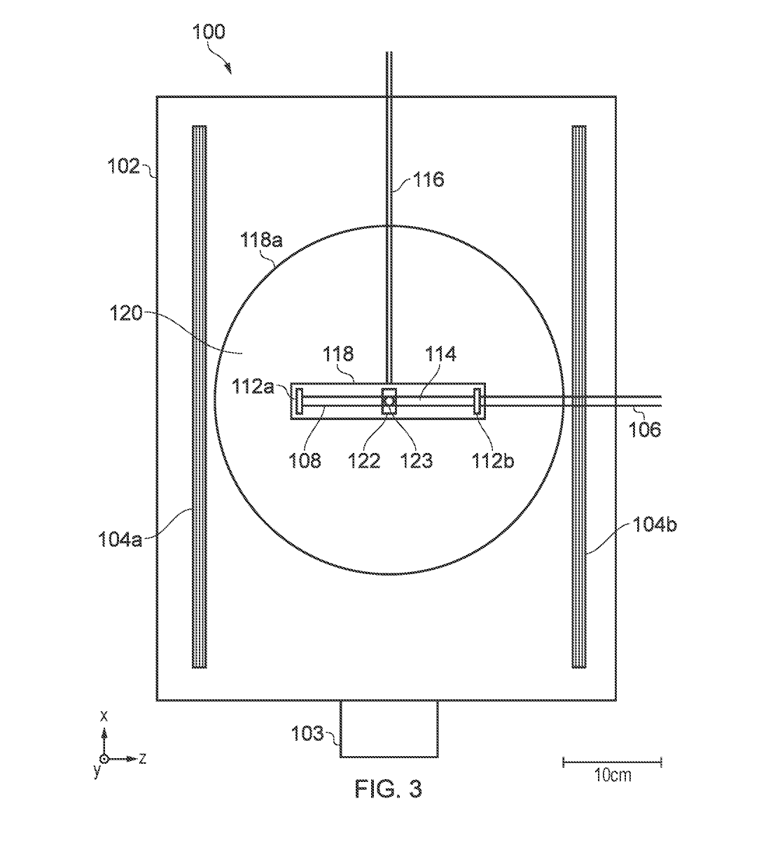

Magnetic coils 104a, 104b are mounted in a Helmholtz arrangement, the plane of each coil being perpendicular to the z-axis. The coils 104a, 104b generate a highly uniform static magnetic field B, in the +z-direction, in embodiments for which this is employed. Cylindrical sample chamber 110 also extends along the z-axis, located equidistantly between coils 104a and 104b. Optical resonator 108 is contained within sample chamber 110. The optical resonator 108 shown most clearly in FIGS. 2 and 3 is made up of two circular concave mirrors 112a and 112b, defining a Fabry-Pérot cavity 114 therebetween. Minors 112a and 112b are respectively located close to each end face of the cylindrical sample chamber 110, with their reflective sides 112a, 112b facing each other to define the Fabry-Pérot cavity 114 therebetween. Inlet 116 delivers both cold helium gas and sample molecules into the sample chamber 110. The inlet 116 extends in the x-direction, and opens into the sample chamber 110 at the midpoint of its curved surface. This allows the sample molecules to enter the path of the illuminating light in the optical resonator 108.

High intensity visible or infrared light is provided by a light source (not shown) to the optical resonator 108 (where it is distilled) via the optical input 106. The optical input extends in the z-direction.

Minors 118a and 118b have spherical surfaces, and define a microwave Fabry-Pérot cavity 120 between them. As shown in FIG. 3, the mirrors 118a, 118b have a circular shape when viewed along the y-axis, and have their centres along the same line in the y-direction. In one embodiment, the minors 118a, 118b may be made from 6061 aluminium alloy, each with a radius of curvature of 0.84 m, and a diameter of 0.48 m, separated by a distance of between 0.5-0.7 m. This arrangement forms a microwave Fabry-Pérot cavity, which is usually operable with frequencies ranging from 4.5-18 GHz, and with a Q-factor of 10⁴, decay time of 10⁻⁶ s, and a frequency bandwidth of 1 MHz. A microwave pulse, linearly polarized in the z-direction is coupled into the cavity 120 via C-band (1 cm×2 cm) waveguide 122, through a 0.01 m iris 123. The backs of the minors 118a, 118b are ground to a thickness of 1 mm to optimize impedance matching.

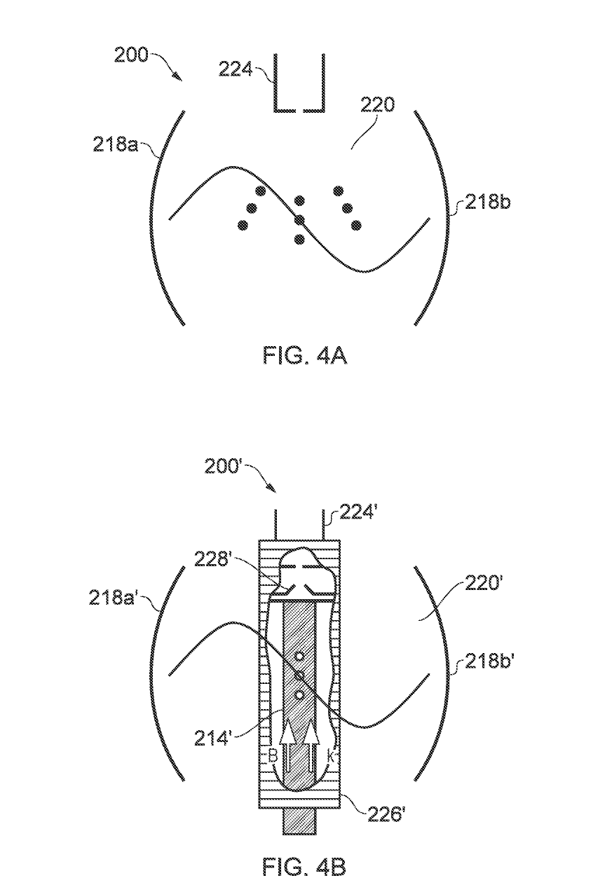

FIG. 4A is a schematic diagram of a typical Balle-Campbell-Keenan-Flygare pulsed nozzle Fourier transform microwave spectrometer. Spectrometer 200 includes a pair of minors 218a, 218b which define a Fabry-Pérot cavity 220 between them. This cavity 220 is evacuated via a pump which is not shown. Nozzle 224 is configured to introduce sample molecules into the cavity 220. Sample molecules are introduced to the cavity 220 in pulses, and are polarized by microwave pulses applied to the cavity 220. FIG. 4B shows a modified version of the spectrometer shown in FIG. 4A, which is another embodiment of the present invention. FIG. 4B represents an alternative possible configuration from the embodiment shown in FIGS. 1, 2 and 3.

According to the embodiment shown in FIG. 4B, spectrometer 200′ includes a pair of mirrors 218a′ and 218b′, defining a microwave Fabry-Pérot cavity 220′ between them. Sample molecules enter the spectrometer in the form of pulses, as in the spectrometer 200 shown in FIG. 4a. In order to collimate the beam, after passing through the nozzle 224′, the molecules pass through a skimmer 228′. A magnetic field B in the +z-direction is applied by solenoid 226′ in the centre of the cavity 220′. Inside the solenoid 226′, and parallel to the long axis of the solenoid 226′, the optical cavity 214′ of a laser is located. The sample molecules are illuminated with high-intensity circularly polarized light with wave vector k, in the optical cavity 214′. As shown in FIG. 4b, the wave vector k is in the same direction as the magnetic field B.

In order to demonstrate how the present invention enables the measurement of individual polarizability components and determination of enantiomeric constitution of a sample, we now discuss in more detail a chiral molecule with unimpeded rotational degrees of freedom, as may be found, for example, in a suitable molecular beam.

In a first step, it is assumed that the molecule occupies its vibronic ground state, in which it is small, polar and non-magnetic, and that each of its nuclear spins are either 0 or 1/2.

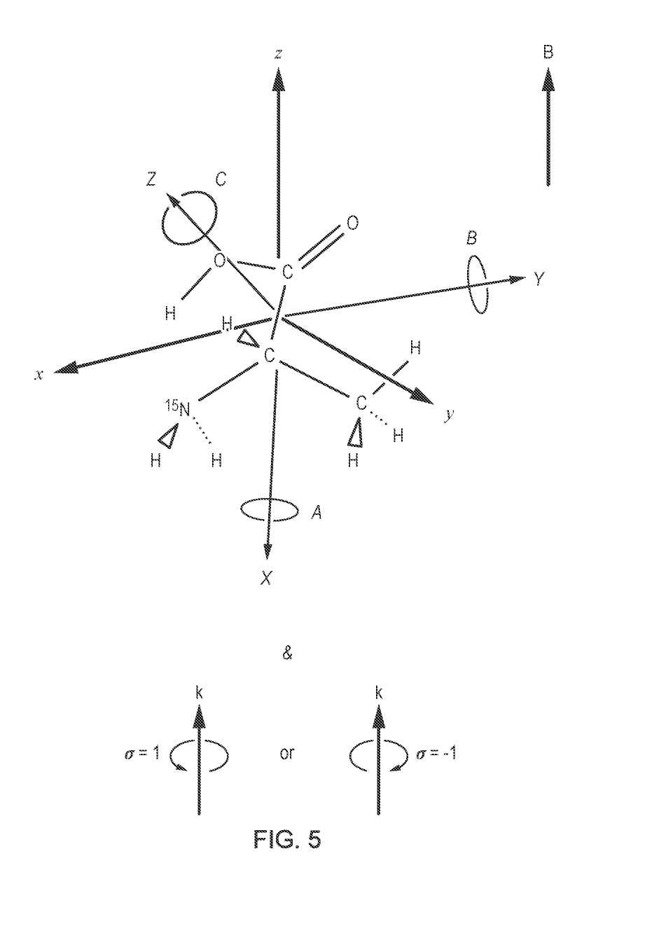

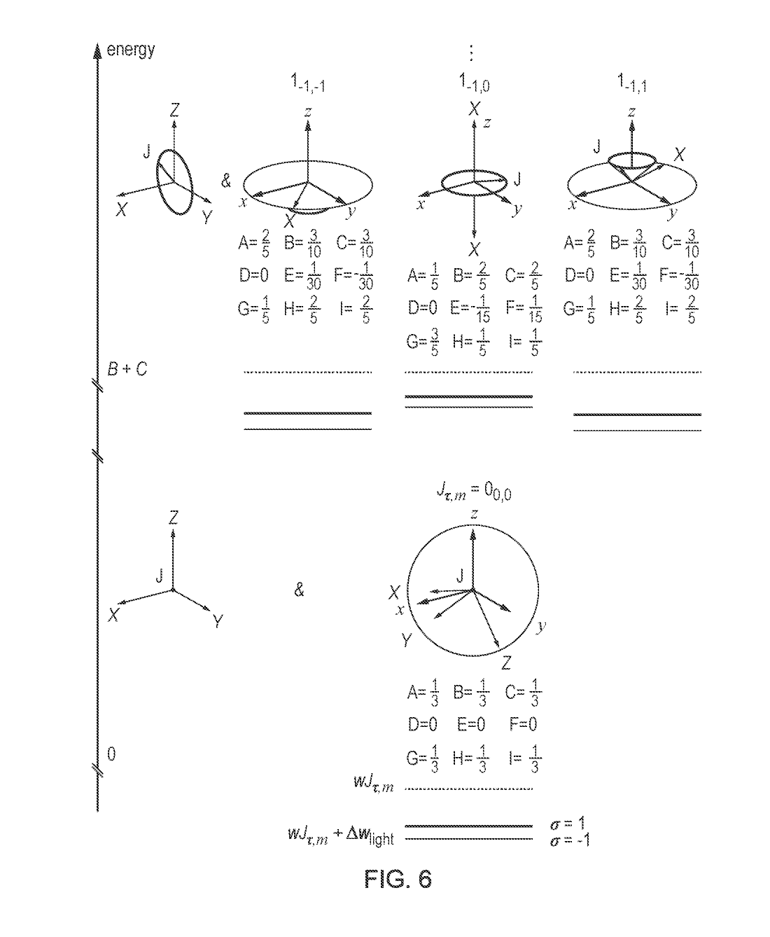

In this way, the molecule is amenable to standard rotational spectroscopy and there is no need to consider the effects of vibrations, electron orbital angular momentum, electron spin and nuclear electric quadrupole moments—which are irrelevant for the purposes of the present invention. If we now consider the presence of a static magnetic field B, of moderate strength, pointing in the +z-direction, the rotational degrees of freedom of the molecule can be considered separately from the nuclear spin degrees of freedom, and both are quantized along the z-direction. The rotation of the molecule is considered as the rotation of an asymmetric rigid rotor, with equilibrium rotational constants A>B>C associated with rotations about molecule-fixed principal axes of inertia X, Y and Z, as shown in FIG. 5. Some of the molecule's low-lying rotor states |J_{τ,m} [symbol] and rotor energies w_{Jτ,m} are shown in FIG. 6.

In J_{τ,m}=0_{0,0} rotor state, the molecule possesses no rotor energy, because it is not rotating. All orientations of X, Y and Z relative to x, y and z are therefore equally likely to be found. In the rotor states, however, the molecule possesses a rotor energy of B+C, as it will never be found rotating about the X axis, but is equally likely to be found rotating about the Y or Z axes. The conceivable motions of the rotor then conspire such that for m=±1 the X axis is most likely to be found in the x-y plane, whereas for m=0 the X axis is most likely to be found perpendicular to the x-y plane. Analogous observations hold for the 1_{0,m} rotor states, in which it is the Y axis which is treated preferentially, and the 1_{1,m} rotor states in which it is the Z axis. Moreover, they can be extended to the J ∈{2, . . . } manifolds though the analysis becomes increasingly complex as J increases.

Importantly for this invention, the rotation and hence orientation of the molecule in any given rotor state is not isotropic in general and differs for different rotor states. The molecule can thus be regarded as a sample of orientated character.

Suppose now that the molecule is introduced to far off-resonance circularly-polarized light of intensity I and (central) wavevector k which points in the z-direction. This light drives oscillations in the charge and current distributions of the molecule. When considering the molecule over time scales at which the probability of absorption and spontaneous decay is negligible, there is an interaction energy ΔW_{light} associated with these driven oscillations, as set out above. ΔW_{light} is in fact the a.c. Stark shift, but calculated by the inventors to a higher order than usual.

It is intuitive that the interaction energy ΔW_{light} depends on molecular polarizability components since these characterize the susceptibility of the charge and current distributions of the molecules to be distorted by the electric and magnetic fields of the incident light. That ΔW_{light} also depends on the rotor state of the molecule (through A, B, C, D, E, F, G, H, and I) is also intuitive since the rotation and hence orientation of the molecule relative to the electric and magnetic field vectors of the light, which reside in the x-y plane, differs for different rotor states. For example, if the molecule occupies the 0_{0,0} state, the light drives oscillations along the X, Y and Z axes (i.e. A=B=C=1/3); if the molecule occupies the 1_{-1,±1} rotor state, the light drives oscillations more frequently along the X axis (A=2/5) and less frequently along the Y and Z axes (B=C=3/10); if the molecule occupies the 1_{-1,0} rotor state, the light drives oscillations less frequently along the X axis (A=1/5) and more frequently along the Y and Z axes (B=C=2/5).

That ΔW_{light} depends on the helicity of the light (through the Iσ(A′G′_{XX}+B′G′_{YY}+C′G′_{ZZ}) and Iσ|k|(DA_{X,YZ}+EA_{Y,XZ}+FA_{Z,XY}) terms) arises because the molecule is chiral: one enantiomorphic form of the helically twisting electric and magnetic field vectors that comprise LCP or RCP polarized light is more competent at driving these oscillations than the other. The same logic applies for a fixed circular polarization and opposite molecular enantiomers. This rotor state-dependent and chirality-dependent molecular energy shift ΔW_{light} represents an oriented chiroptical response.

### EXAMPLES

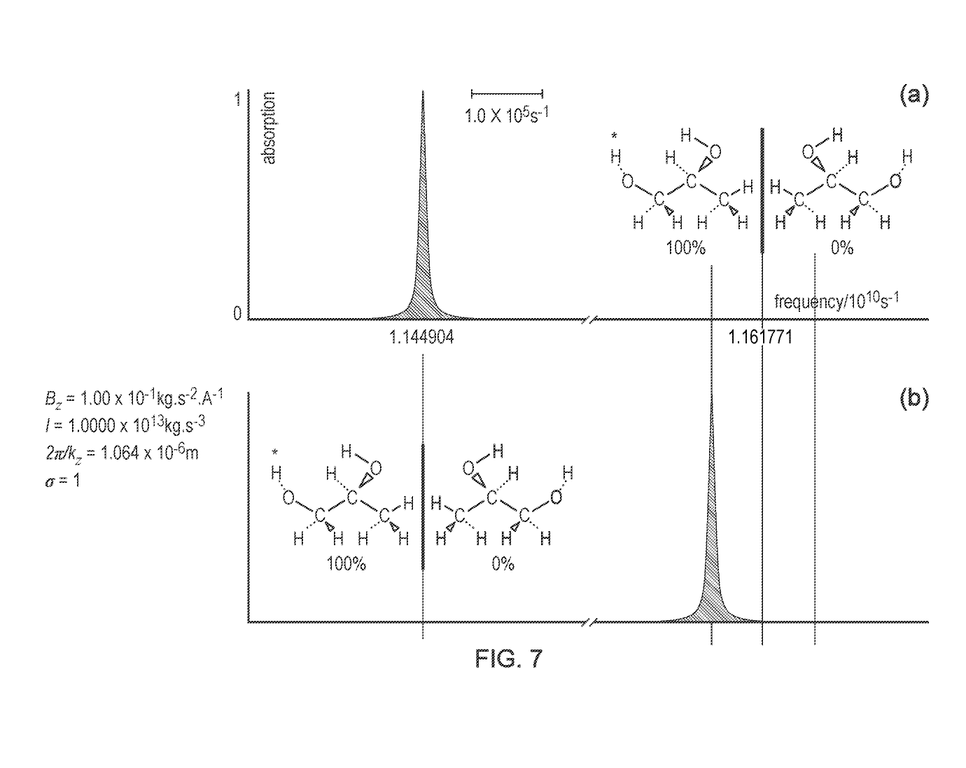

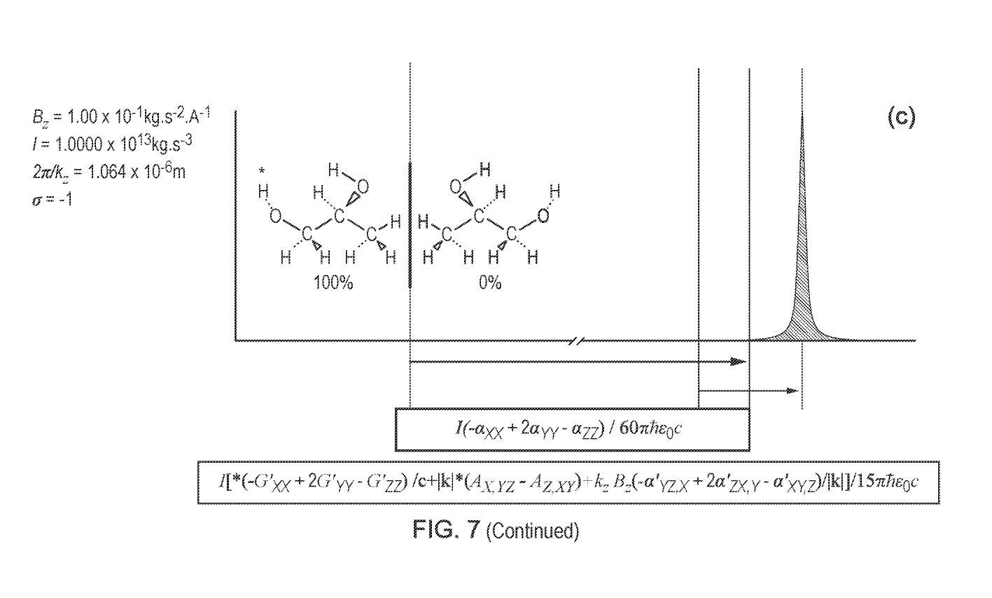

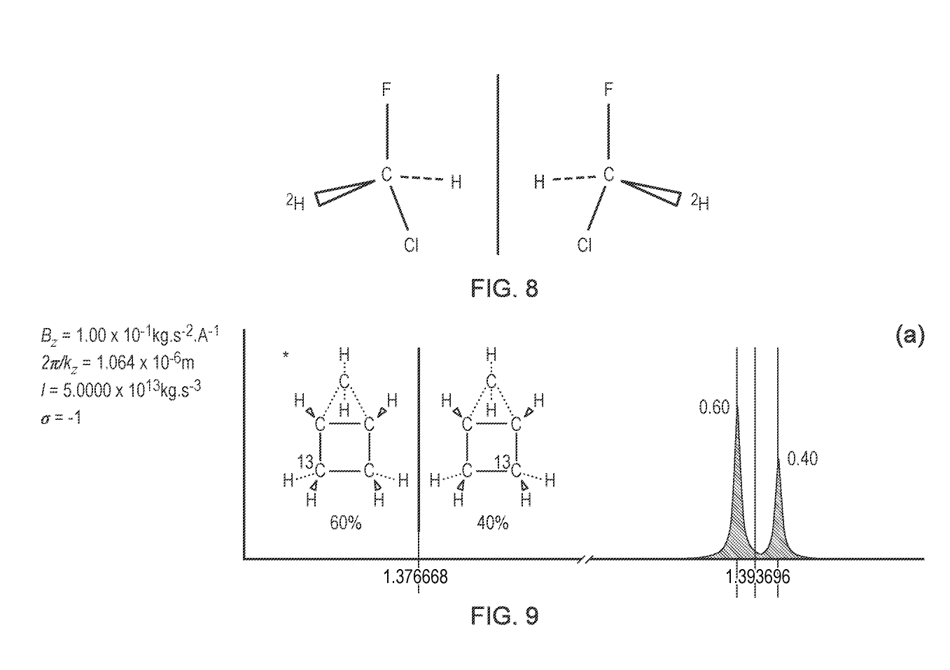

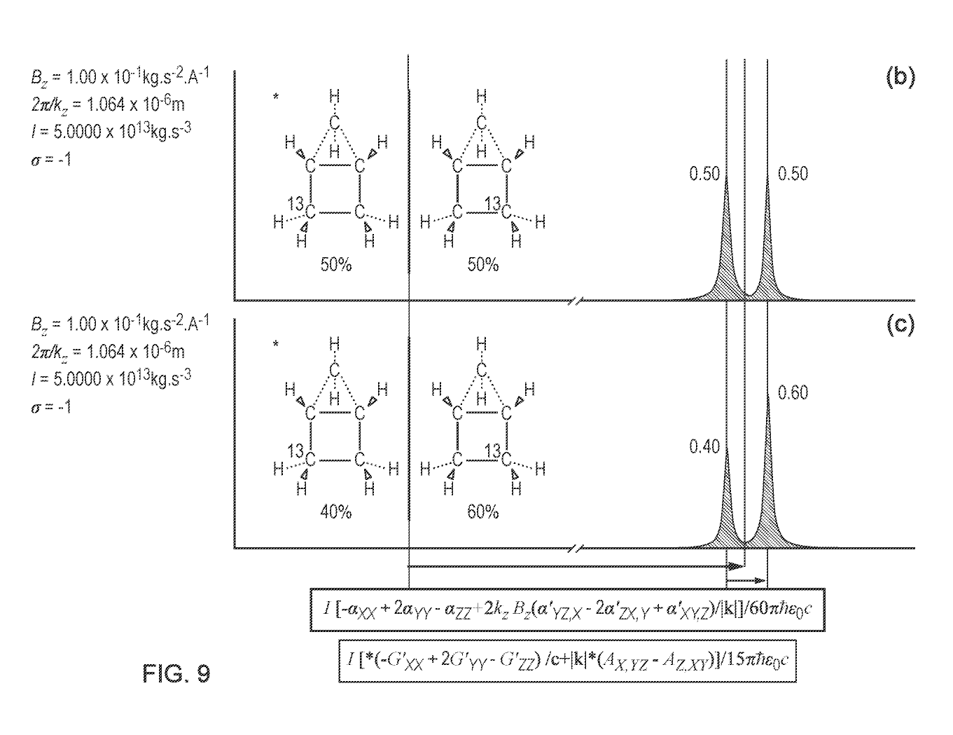

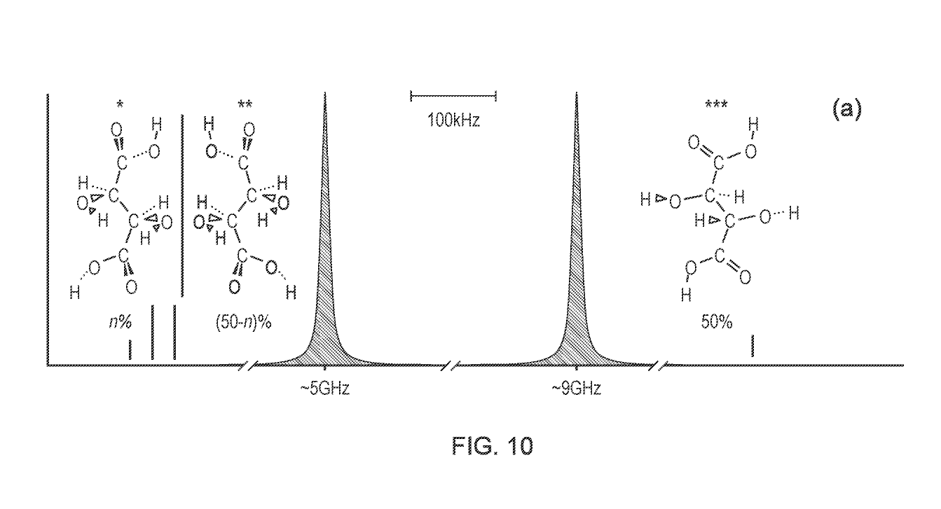

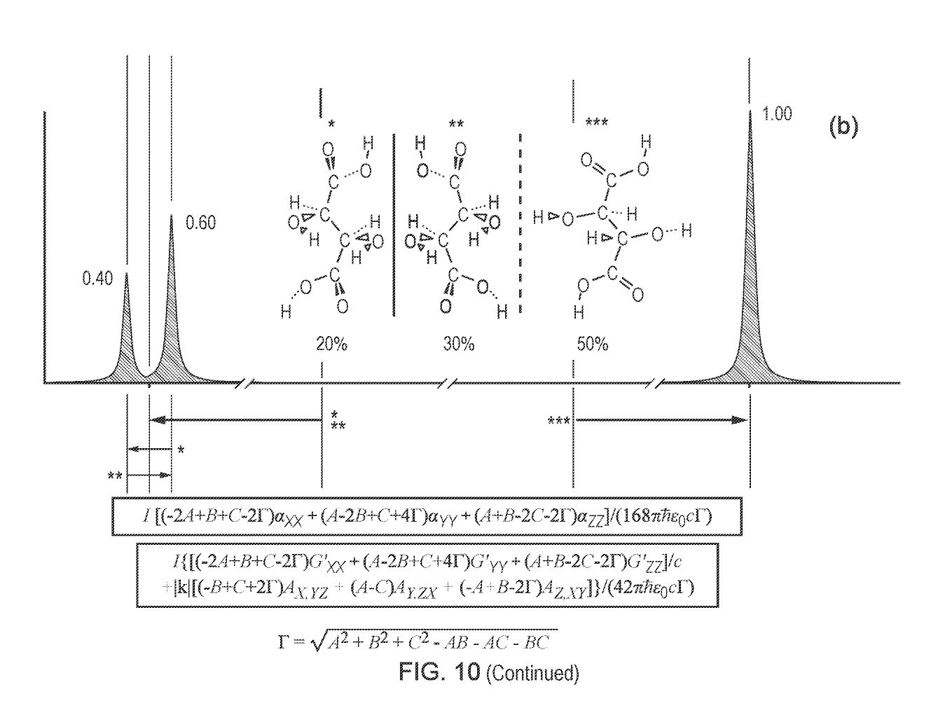

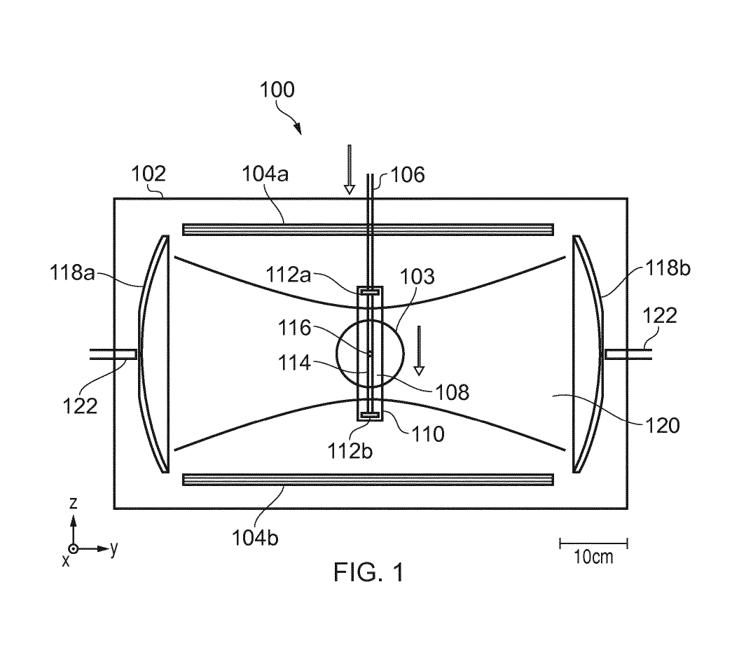

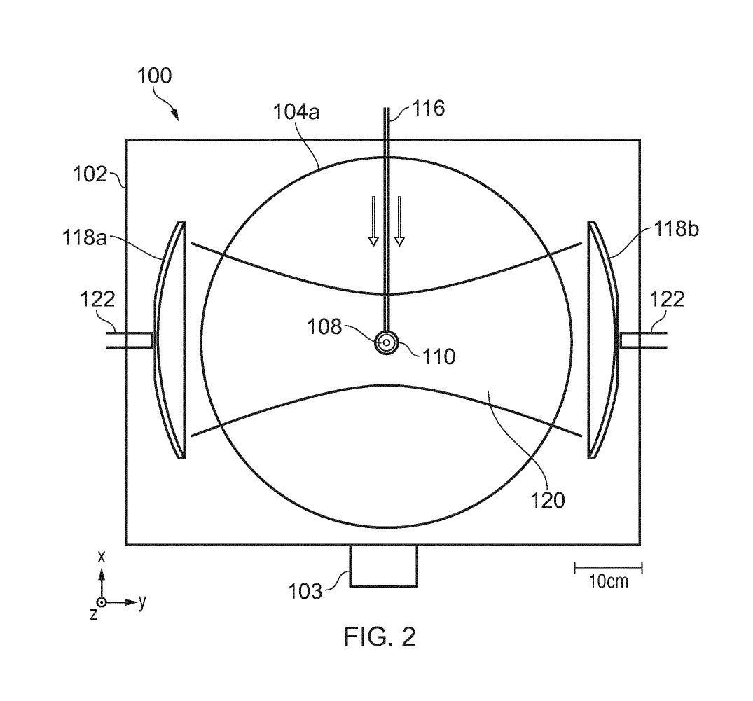

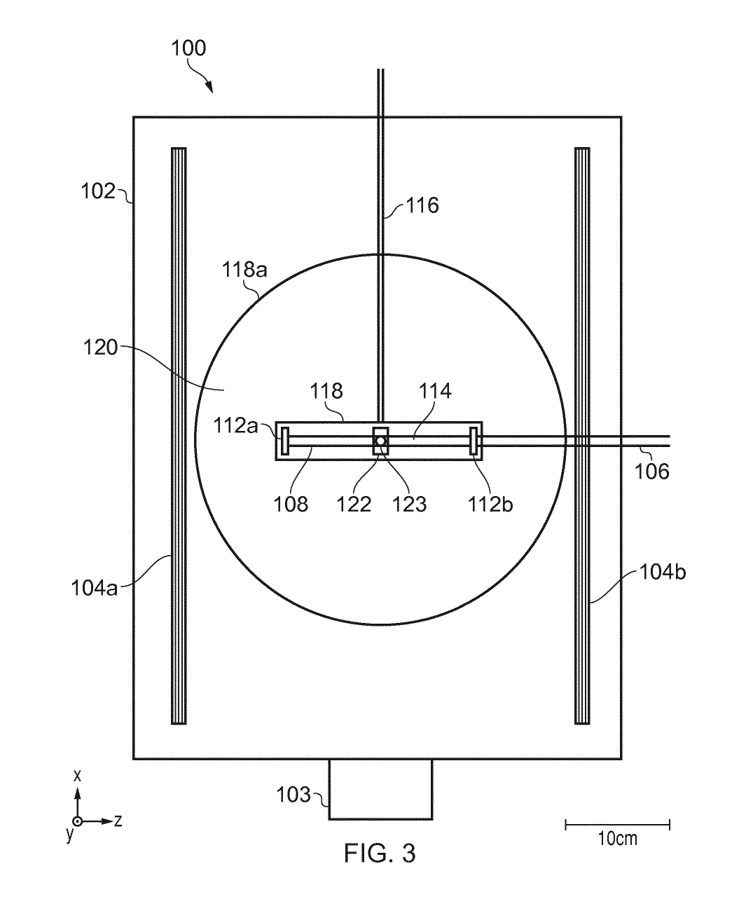

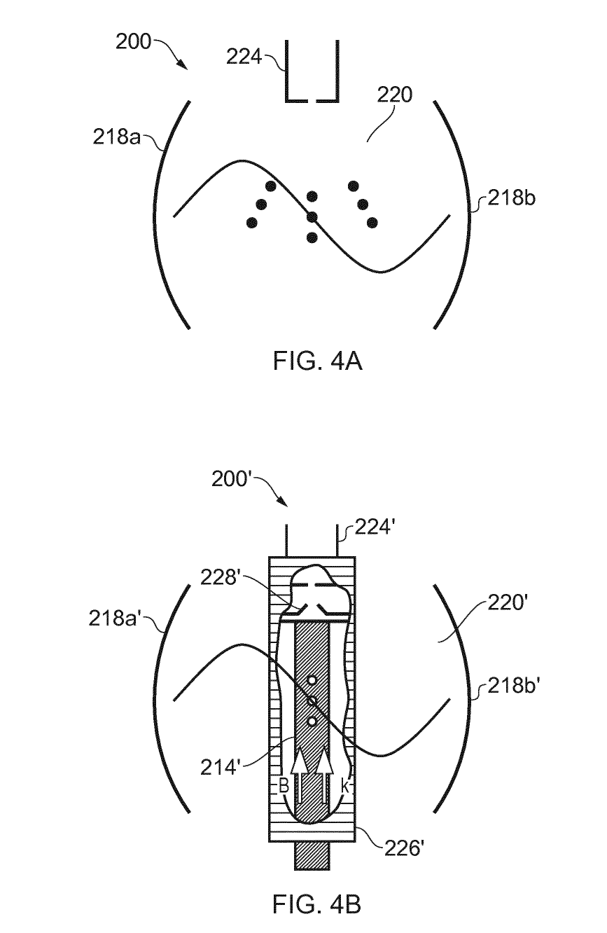

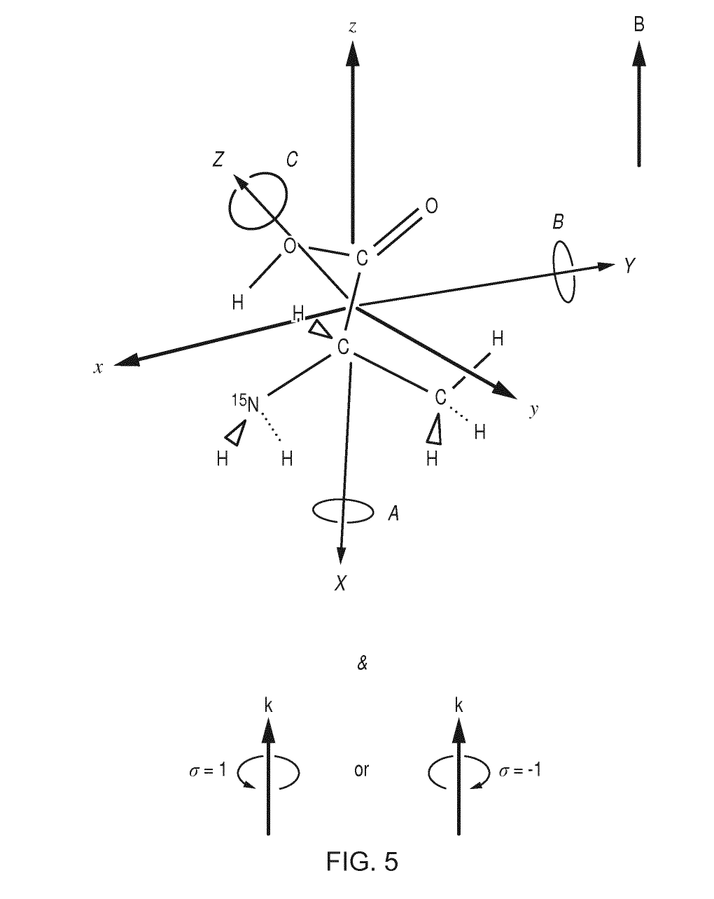

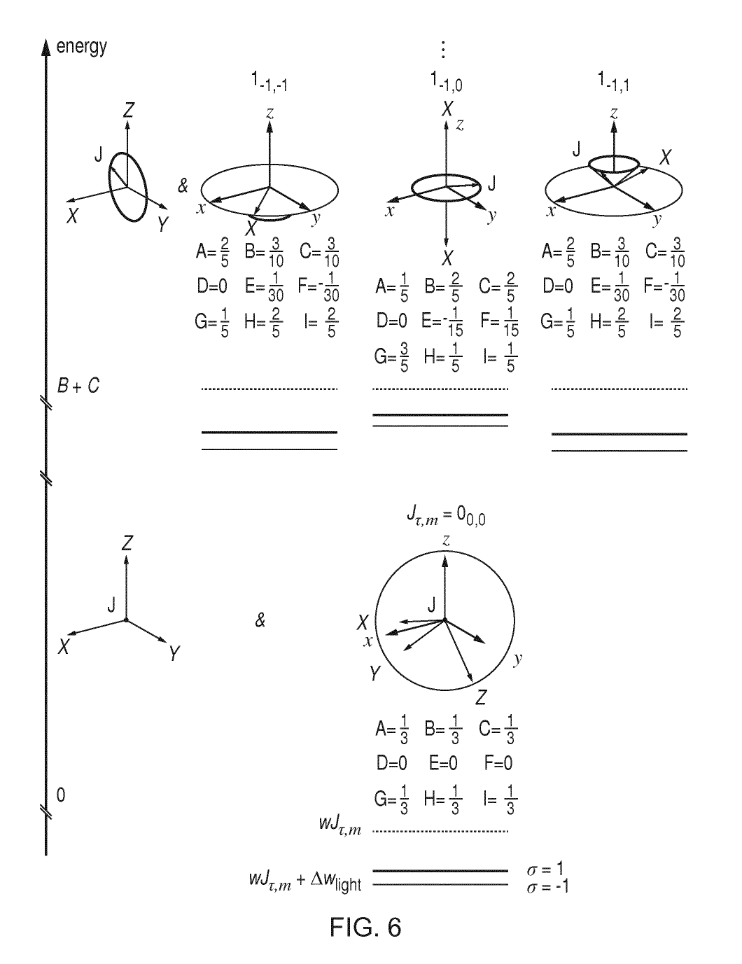

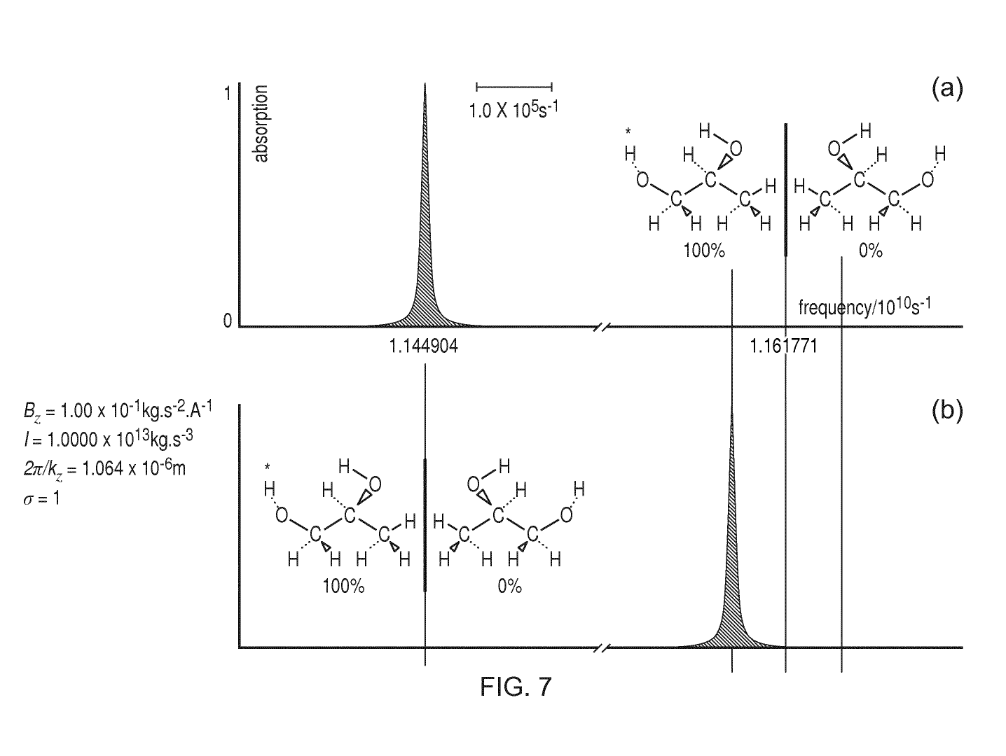

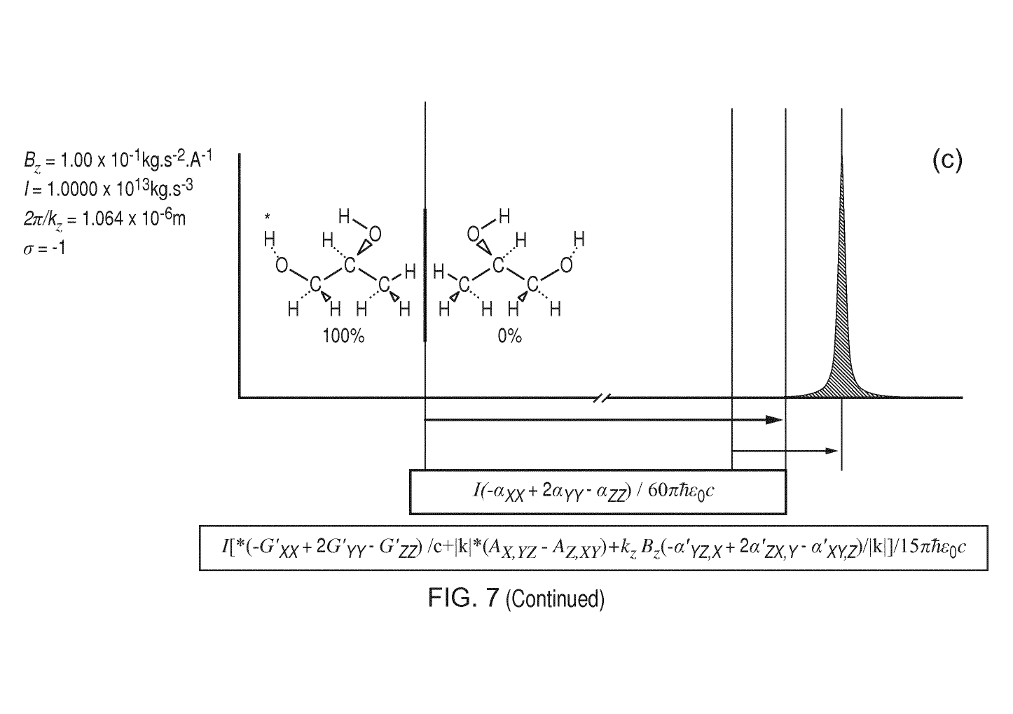

Consider first an enantiopure sample of the lowest energy conformer of (S)-propylene glycol. Racemic propylene glycol is employed as an antifreeze and is a key ingredient in electronic cigarettes. FIG. 7 shows a hyperfine component of the 1_{0,0}←0_{0,0} absorption line (a) in the absence of a magnetic field B and the light (b) in the presence of the magnetic field B and LCP light (c) in the presence of the magnetic field B and RCP light. The separation between line (a) and the centroid of lines (b) and (c) yields a certain component of Δ_{XX}, α_{YY}, and α_{ZZ}, while the separation between lines (b) and (c) yields a certain combination of G′_{XX}, G′_{YY}, G′_{ZZ}, A_{X,YZ}, A_{Y,ZX} and A_{Z,XY} together with a contribution from α′_{YZ,X}, α′_{ZX,Y}, and α′_{XY,Z}.

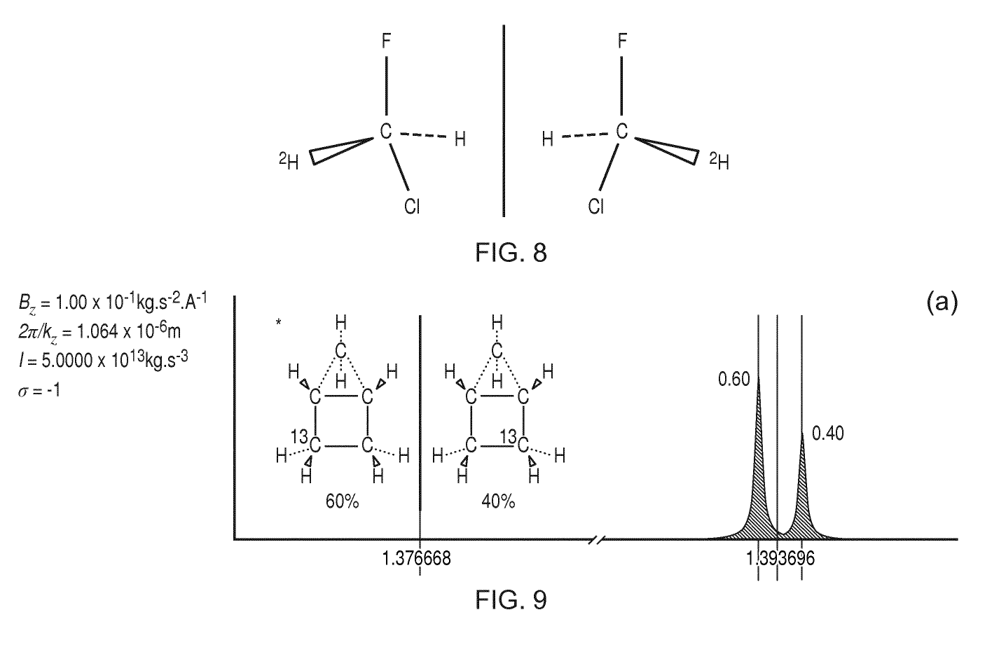

Measuring G′_{XX}, G′_{YY}, G′_{ZZ}, A_{X,YZ}, A_{Y,XZ} and A_{Z,XY} and hence chiral rotational spectroscopy could find particular use in the analysis of molecules with multiple chiral centres and more challenging manifestations of molecular chirality, for example isotopic molecular chirality, wherein an otherwise achiral arrangement of atoms exhibits chirality by virtue of its isotopic constitution, as shown in FIG. 8. It has been suggested that isotopic molecular chirality may have played a role in the formation of biological homochirality. Isotopically chiral molecules have also been put forward as promising candidates for the measurement of minuscule differences believed to exist between the energies of opposite molecular enantiomers. It has been shown that the isotropic sum ⅓(G′_{XX}+G′_{YY}+G′_{ZZ}) vanishes for an isotopically chiral molecule, since the sum is origin independent and rotationally invariant, and the charge and current distributions of the molecule are achiral. However, it is found that the components G′_{XX}, G′_{YY}, G′_{ZZ}, A_{X,YZ}, A_{Y,ZX} and A_{Z,XY} can individually attain appreciable magnitudes for an isotopically chiral molecule. This is because each of these components is dependent upon the location of the molecule's centre of mass and the orientation of the principal inertial axes X, Y and Z, and so is sensitive to the distribution of mass throughout the molecule, which is where the molecule's chirality resides. The technique of the present invention is thus inherently sensitive to isotopic molecular chirality.

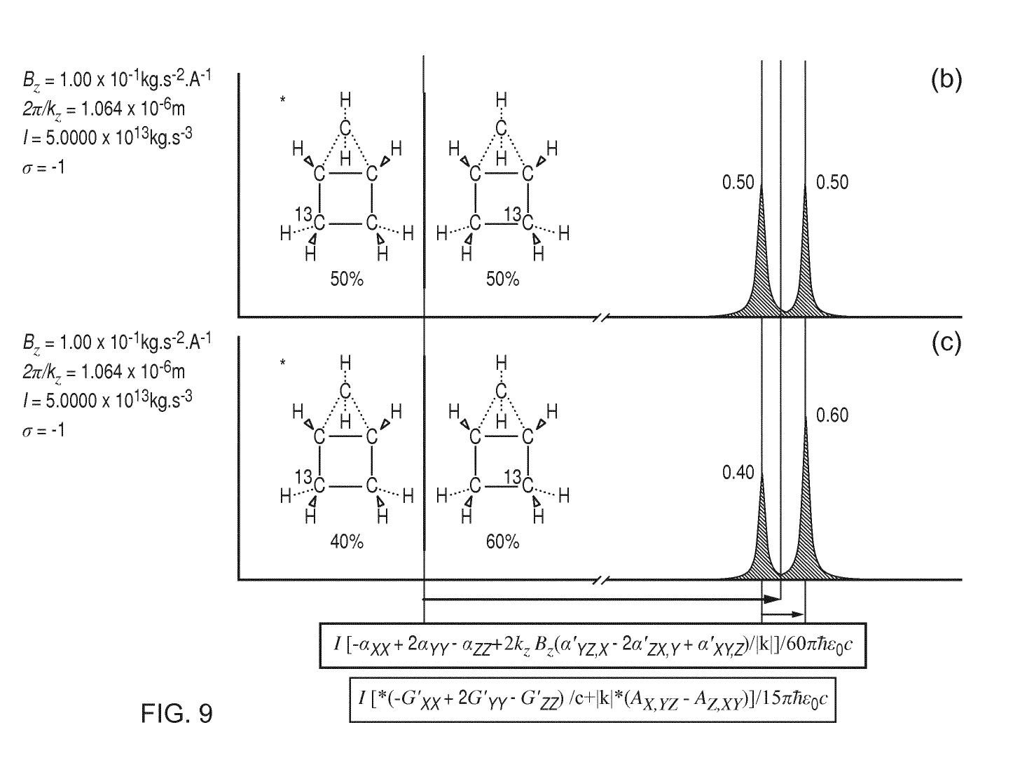

Consider then a non-enantiopure sample of housane, with the usual C atom at either the bottom-left or bottom-right of the “house” substituted with a ¹³C atom to give the opposite enantiomers of an isotopically chiral molecule. FIG. 9 shows a hyperfine component of the 1_{0,0}←0_{0,0} absorption line in the presence of B and RCP light for a sample comprising (a) a 60:40 mixture of opposite molecular enantiomers, (b) a 50:50 mixture, and (c) a 40:60 mixture. The spectrum is manifestly sensitive to the chirality of the molecules. The relative heights of the lines reflect the enantiomeric constitution of the sample and so enable its determination. A non-vanishing and incisive signal is even obtainable for a racemic mixture, as shown in (b). Such a signal could not be obtained using techniques such as electronic optical rotation and electronic circular dichroism, which are virtually blind to isotopic molecular chirality. Even techniques such as vibrational circular dichroism and Raman optical activity would yield a vanishing signal for this example.

Chiral rotational spectroscopy can be employed even when the preparation of an enantioenriched sample is difficult or impossible, as is typically the case for isotopically chiral molecules. Enantioenriched samples of isotopically chiral molecules can often only be synthesized in small quantities while resolution of racemic mixtures is usually almost impossible.

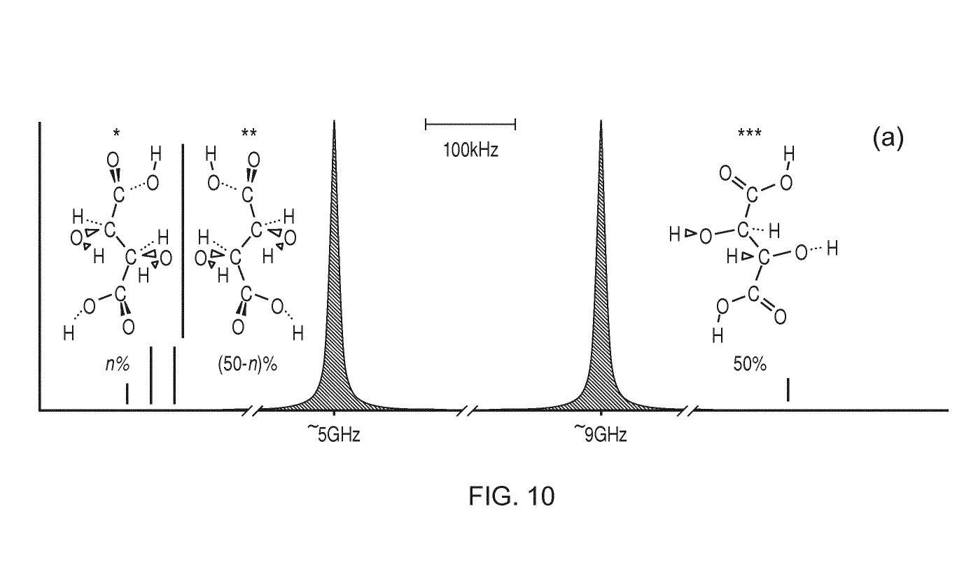

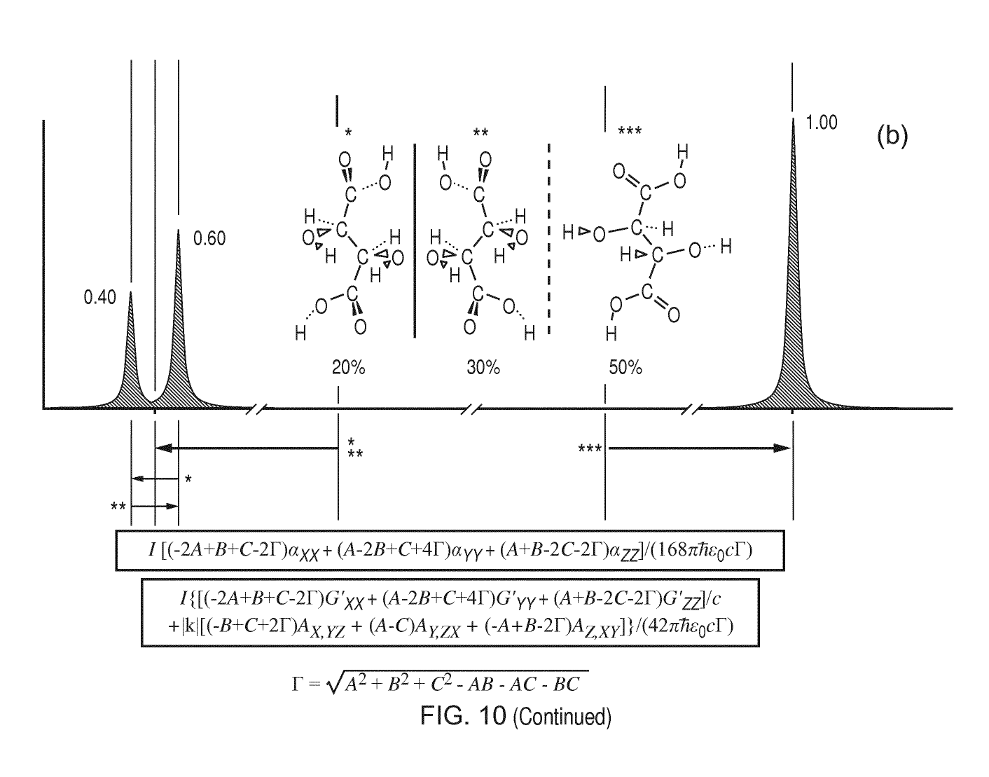

Standard rotational spectroscopy can often distinguish well between different isomers, provided they are not opposite enantiomers. Chiral rotational spectroscopy can distinguish well between different isomers including opposite enantiomers. It may find particular use, therefore, in the analysis of molecules with multiple chiral centres, which permit a large number of different stereoisomers, many of which are opposite enantiomers. This in turn could see chiral rotational spectroscopy find particular use in the food and pharmaceutical industries, where the existence of different isomers must be individually identified and molecules with multiple chiral centres are recognised as being “challenging”. This effective is demonstrated in FIG. 10 by considering a sample of tartaric acid.

Tartaric acid has two chiral centres which permit three different stereoisomers. One of these, mesotartaric acid, is achiral whilst the other two, L-tartaric acid and D-tartaric acid, are opposite enantiomers. L-tartaric acid is found in grapes and bananas and was one of the first molecules recognised as being optically active. The racemate of L- and D-tartaric acid, also known as paratartaric acid or racemic acid, was the subject of Pasteur's original chiral separation.

Panel (a) of FIG. 10 depicts the 2₂←2₀ line for a n: (50−n):50 mixture of L-tartaric, D-tartaric and mesotartaric in the absence of light. The contribution due to mesotartatic acid appears well separated from those due to L-tartaric acid and D-tartaric acid. The spectrum gives no information, however, about the relative abundances of L-tartaric acid and D-tartaric acid.

Panel (b) of FIG. 10 depicts the 2_{2,±1}←2_{0,0} line for a 20:30:50 mixture in the presence of light with wavelength 2π/|k|=5.12×10⁻⁷ m, intensity I=10¹² kg·s⁻³ (i.e. I=10⁸ W·cm⁻²) and left-handed circular polarisation σ=1. Contributions due to all three stereoisomers now appear well distinguished whilst yielding a wealth of new information. Rotational spectra are sufficiently sparse that the analysis of molecules with significantly more chiral centres should not be met with any fundamental difficulties.

The schematic spectral data shown in FIGS. 7, 9 and 10 was obtained using theoretical values calculated for the polarizability components α_{XX}, α_{YY}, α_{ZZ}, G′_{XX}, G′_{YY}, G′_{ZZ}, A_{X,YZ}, A_{Y,ZX} and A_{Z,XY} using a relay tensor dynamic coupling model together with molecular data taken or extrapolated from the literature. The inventors have found from numerical investigations that hyperfine splittings deriving from nuclear spin-spin and nuclear spin-rotation intramolecular interactions are of little importance at a frequency resolution of 10³ s⁻¹ for the molecules and transitions under consideration. In addition, effects due to the spin statistics of similar nuclei were ignored. The rotational transition lines are plotted as Lorentzians centred at the average transition frequencies, with each Lorentzian being ascribed a frequency full-width at half-maximum of 1.0×10⁴ s⁻¹ and taken to be proportional in amplitude to the number of contributing molecules.

Whilst the assumptions above may require some refinement of the detail shown in FIGS. 7, 9 and 10, these examples nevertheless suffice to illustrate some of the basic features of chiral rotational spectra and give a fair idea of what may be possible. The strengths and shapes of lines seen in a real chiral rotational spectrum will depend upon the nature and functionality of the chiral rotational spectrometer used to obtain it.

Rotational spectroscopy has already proven itself useful in astronomy, having enabled the identification of a modest collection of molecular species in space. The principles underpinning the present invention may also be exploited to bolster the search for chiral species in particular. For example, a telescope may be trained on a region where chiral molecules and intense circularly polarised light are believed to exist simultaneously. Rotational spectral data may be obtained for signatures of molecular chirality.

The disclosure herein is discussed further in an publication [1] by the inventors made after the priority date of the present case. In that publication, the physically meaningful and origin independent combinations

$${B}_{XX} = - \frac{{G}_{XX}^{′}}{c \vert k \vert} + \frac{1}{3} ( {A}_{Y , ZX} - {A}_{Z , XY} )$$

$${B}_{YY} = - \frac{{G}_{YY}^{′}}{c \vert k \vert} + \frac{1}{3} ( {A}_{Z , XY} - {A}_{X , YZ} )$$

$${B}_{ZZ} = - \frac{{G}_{ZZ}^{′}}{c \vert k \vert} + \frac{1}{3} ( {A}_{X , YZ} - {A}_{Y , ZX} )$$

are identified and the rotational averages a_{J,τ}(|m|), b_{J,τ}(|m|) and c_{J,τ}(|m|) are introduced. The notation used in the publication maps to the notation used herein as shown in the following table:

| Notation used herein | Notation used in [1] |
|---|---|
| A = −cA′/2 | −a_{J,τ}(\|m\|)/2ϵ₀c |
| B = −cB′/2 | −b_{J,τ}(\|m\|)/2ϵ₀c |
| C = −cC′/2 | −c_{J,τ}(\|m\|)/2ϵ₀c |
| D | [b_{J,τ}(\|m\|) − c_{J,τ}(\|m\|)]/3ϵ₀c |
| E | [c_{J,τ}(\|m\|) − a_{J,τ}(\|m\|)]/3ϵ₀c |
| F | [a_{J,τ}(\|m\|) − b_{J,τ}(\|m\|)]/3ϵ₀c |
| G | [1 − 2b_{J,τ}(\|m\|) − |
| | 2c_{J,τ}(\|m\|)]/2ϵ₀c |
| H | [1 − 2c_{J,τ}(\|m\|) − |
| | 2a_{J,τ}(\|m\|)]/2ϵ₀c |
| I | [1 − 2a_{J,τ}(\|m\|) − |
| | 2b_{J,τ}(\|m\|)]/2ϵ₀c |

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting.

### REFERENCES

[1] Robert P. Cameron, Jörg B. Götte and Stephen M. Barnett 2016 Chiral rotational spectroscopy Physical Review A 94 032505

1. A method of rotational spectroscopy, the method comprising:
introducing a sample into a sample chamber, wherein the sample comprises freely rotatable molecules;
illuminating the sample with off-resonance optical radiation having a polarization selected to introduce a shift in rotational energy levels of the sample molecules; and
while the sample is illuminated with the off-resonance optical radiation, irradiating the illuminated sample with probing radiation to obtain rotational spectral data from which the shift in rotational energy levels of the sample molecules can be derived.

2. A method according to claim 1 including applying a static magnetic field across the chamber to decouple nuclear spin angular momentum of the molecules from its rotor angular momentum.

3. A method according to claim 1, wherein the sample is a gas or a molecular beam.

4. A method according to claim 1, wherein the optical radiation is in the visible or infrared parts of the spectrum.

5. A method according to claim 1, wherein the optical radiation is linearly polarized.

6. A method according to claim 1, to wherein the optical radiation consists of one or more components that are circularly or elliptically polarized.

7. A method according to claim 1 including analyzing the rotational spectral data to determine an enantiomeric constitution of the sample.

8. A method according to claim 1 including analyzing the rotational spectral data to extract individual molecular polarizability components for molecules in the sample.

9. A method according to claim 8, wherein the individual molecular polarizability components are any one or more of electric-dipole/magnetic-dipole polarizability components G′_{XX}, G′_{YY}, and G′_{ZZ}, and electric-dipole/electric-quadrupole polarizability components A_{X,YZ}, A_{Y,ZX} and A_{Z,XY} .

10. A method according to claim 8, wherein the individual molecular polarizability components are any one of more of electric-dipole/electric-dipole polarizability (α_{XX}, α_{YY}, α_{ZZ}), and “Faraday-B” polarizability ( α′_{YZ,X}, α′_{ZX,Y}, and α′_{XY,Z}).

11. A method according to claim 1 including comparing the rotational spectral data with reference data to determine information about the sample.

12. A method according to claim 1, wherein the rotational spectral data comprises any one of rotational absorption spectral data, transmission data and free-induction decay data.

13. A method according to claim 1, wherein the probing radiation is microwave or radiofrequency energy.

14. A method according to claim 1, wherein the optical radiation has an intensity of no less than 10⁴ W·cm⁻².

15. A method according to claim 1, including cooling the sample to less than 50 K before the illuminating and irradiating steps.

16. A spectrometer for performing molecular rotational spectroscopy, the spectrometer comprising:
a sample chamber for receiving and retaining a sample comprising freely rotatable molecules;
an optical source configured to illuminate the sample chamber with off-resonance optical radiation having a polarization selected to introduce a shift in rotational energy levels of the sample molecules;
a probing radiation generator configured to irradiate the sample in the sample chamber with probing radiation while the sample is illuminated with the off-resonance optical radiation; and
a detector configured to detect rotational absorption spectral data from which the shift in rotational energy levels of the sample molecules can be derived.

17. A spectrometer according to claim 16 including a magnetic field generator arranged to apply a static magnetic field across the sample chamber to decouple nuclear spin angular momentum of the molecules from its rotor angular momentum.

18. A spectrometer according to claim 17, wherein the magnetic field generator is configured to apply a substantially uniform field within the sample chamber.

19. A spectrometer according to claim 16, wherein the optical source comprises an optical resonator.

20. A spectrometer according to claim 19, wherein the optical resonator comprises a cavity which is contained wholly or partly within or part of the sample chamber.

21. A spectrometer according to claim 20, wherein the cavity is arranged to support a particular polarization of light.

22. A spectrometer according to claim 21, wherein the optical source includes a polarizing element arranged to introduce a polarisation to the optical radiation.

23. A spectrometer according to claim 22, wherein the polarizing element is located outside the sample chamber.

24. A spectrometer according to claim 16, wherein the probing radiation generator comprises a microwave cavity, and wherein the sample chamber is contained within the microwave cavity.

25. A spectrometer according to claim 24, wherein the size of the cavity is adjustable to operate at different frequencies of probing radiation.

26. A spectrometer according to claim 25, wherein the cavity is defined by a pair of opposed mirrors, wherein a separation between the mirrors is adjustable.

27. A spectrometer according to claim 16, wherein the sample chamber includes a cooling mechanism arranged to maintain the temperature of the sample at less than 50 K.

28. A spectrometer according to claim 16 includes a vacuum chamber for containing the sample chamber and probing radiation generator, wherein the vacuum chamber is arranged to maintain the sample in a low pressure environment.

29. A spectrometer according to claim 16, wherein the sample chamber includes a nozzle arranged to introduce a pulsed molecular beam into the sample chamber.

30. A spectrometer according to claim 16, wherein the sample chamber includes an injection inlet arranged to permit diffusion of a sample through a buffer gas to provide a continuous or quasi-continuous source
